(19) United States
(12) Patent Application Publication
(10) Pub. No.: US 2009/0233475 A1
(43) Pub. Date: Sep. 17, 2009

(54) WATERPROOF GIGABIT ETHERNET CONNECTOR

(75) Inventors: William A. Mildon, Westerly, RI (US); Norman Sylvester, Cumberland, RI (US)

Correspondence Address: RATNERPRESTIA, P.O. BOX 980, VALLEY FORGE, PA, 19482, US

(73) Assignee: AMETEK SCP, INC., Westerly, RI (US)

(21) Appl. No.: 12/046,078

(22) Filed: Mar. 11, 2008

(51) Int. Cl. H01R 13/52; H01R 13/64; H01R 9/05

(52) U.S. Cl. 439/277; 439/374; 439/583

(57) ABSTRACT

A mateable pair of Ethernet connector assemblies for propagating data at Gigabit rates is disclosed. The pair of electrical connector assemblies includes a male Ethernet plug and a female Ethernet receptacle. The male Ethernet plug includes a substantially cylindrical hollow-body shell, an insulator body positioned within the shell, and a plurality of cylindrical pins positioned within respective apertures formed in the insulator body. One end of each pin extends beyond the mating surface of the insulator body for insertion into a respective socket of the female receptacle. The female Ethernet receptacle includes a substantially cylindrical hollow-body shell, an insulator body positioned within the receptacle shell, and a plurality of hollow-body cylindrical sockets positioned within respective apertures formed in the receptacle insulator body. One end of each socket is substantially flush with a mating surface of the receptacle insulator body for receiving a pin of the male Ethernet plug.

### TECHNICAL FIELD

The present invention relates to rugged connectors for Gigabit Ethernet applications.

### BACKGROUND OF THE INVENTION

Gigabit Ethernet (GbE or 1 GigE) describes technologies for transmitting Ethernet frames at a rate of a gigabit per second, as defined by the IEEE 802.3-2005 standard. Ethernet is a physical link and link layer protocol. There are several standards for transmitting Ethernet frames over twisted pair or copper-based computer networking physical connectivity methods. Currently the most widely used of these are 10BASE-T, 100BASE-TX, and 1000BASE-T, running at 10 Mbit/s, 100 Mbit/s, and 1000 Mbit/s (1 Gbit/s) respectively.

The most commonly used standard of Gigabit Ethernet (1000 Mbit/s) over twisted pair is 1000BASE-T, which uses Category 5e cable. Category 5 cable, commonly known as Cat 5, is a twisted pair style cable designed for high signal integrity. IEEE 802.3ab defines standards for 1000BASE-T over category 5 cable. Category 5 has been superseded by the Category 5e specification which is formally defined in the TIA/EIA-568-B standard. Category 5e cable is often used in structured cabling for computer networks such as Ethernet, and is also used to carry many other signals such as basic voice services, token ring, and ATM.

An 8 Position 8 Contact (8P8C hereinafter) modular connector may be coupled to each free end of a category 5e cable for transmitting data packets at Gigabit rates. An 8P8C connector is most commonly used for 100 Mbit/s networks, such as 100BASE-TX Ethernet. Under the naming scheme, an 8P8C connector has eight positions, each associated with a conductor. 8P8C connectors are commonly used for single Ethernet applications, basic voice services, token ring, and ATM, and have replaced many older connector types. Gigabit Ethernet applications may optionally use 8P8C modular connectors, which are commonly referred to as RJ45 in the context of Ethernet over twisted pair.

An 8P8C modular connector (e.g., RJ45) has two forms: the male plug and the female receptacle or jack, each having eight conductors. RJ45 connectors may not be sufficiently robust to withstand moisture, pressure, shock and/or vibration. In view of the foregoing, there is a continuing need to further develop and refine connectors intended for Gigabit Ethernet applications, in the interest of functionality, utility and performance.

### SUMMARY OF THE INVENTION

According to an aspect of the invention, a mateable pair of Ethernet connector assemblies for propagating data at Gigabit rates is provided. The pair of electrical connector assemblies comprises a male Ethernet plug and a female Ethernet receptacle. The male Ethernet plug includes a substantially cylindrical hollow-body shell, an insulator body positioned within the shell and defining a mating surface, and a plurality of cylindrical pins positioned within respective apertures formed in the insulator body. One end of each pin extends beyond the mating surface of the insulator body for insertion into a respective socket of the female receptacle, and a threaded region positioned on or adjacent the shell for threadedly coupling to the female receptacle.

The female Ethernet receptacle includes a substantially cylindrical hollow-body shell, an insulator body positioned within the receptacle shell and defining a mating surface, and a plurality of hollow-body cylindrical sockets positioned within respective apertures formed in the receptacle insulator body. One end of each socket is substantially flush with the mating surface of the receptacle insulator body for receiving a pin of the male Ethernet plug, and a threaded region positioned on or adjacent the receptacle shell for threadedly coupling to the threaded region of the plug shell.

According to another aspect of the invention, a male Ethernet plug assembly for propagating data at Gigabit rates is provided. The plug assembly comprises a substantially cylindrical hollow-body shell, an insulator body positioned within the shell and defining a mating surface, and a plurality of cylindrical pins positioned within respective apertures formed in the insulator body. Adjacent cylindrical pins are spaced apart by a pre-determined distance. One end of each pin extends beyond the mating surface of the insulator body by a predetermined length for insertion into a socket of the female Ethernet receptacle. The opposing end of each pin is configured to be coupled to an electrical wire. A threaded region is positioned on or adjacent the shell for threadedly coupling to a female Ethernet receptacle.

According to yet another aspect of the invention, a female Ethernet receptacle assembly for propagating data at Gigabit rates is provided. The receptacle assembly comprises a substantially cylindrical hollow-body shell, an insulator body positioned within the shell and defining a mating surface, and a plurality of hollow cylindrical sockets positioned within respective apertures formed in the insulator body. Adjacent sockets are spaced apart by a pre-determined distance. One end of each socket is substantially flush with the mating surface of the receptacle insulator body for receiving a pin of a male Ethernet plug. An opposing end of each socket is configured to be coupled to an electrical wire. A threaded region is positioned on or adjacent the shell for threadedly coupling to the male Ethernet plug.

According to still another aspect of the invention, a twisted pair cable assembly for propagating data at Gigabit rates is provided. The twisted pair cable assembly comprises a first twisted pair cable having at least eight conductors, and a second twisted pair cable having at least eight conductors. A male Ethernet plug includes at least eight cylindrical pins, each pin having one end for insertion into a respective socket of a female Ethernet receptacle and an opposing end coupled to a respective conductor of the first twisted pair cable. The female Ethernet receptacle includes at least eight hollow-body cylindrical sockets, each socket having one end for receiving a pin of the male Ethernet plug and an opposing end coupled to a respective conductor of the second twisted pair cable.

### BRIEF DESCRIPTION OF THE FIGURES

The invention is best understood from the following detailed description when read in connection with the accompanying drawing. It is emphasized that, according to common practice, the various features of the drawing are not to scale. Included in the drawing are the following figures:

FIG. 1A depicts an end view of a receptacle of a cable assembly according to one exemplary embodiment of the invention.

FIG. 1B depicts a cross section of the cable assembly of FIG. 1A taken along the lines 1B-1B.

FIG. 2A depicts an end view of a plug of a cable assembly according to one exemplary embodiment of the invention.

FIG. 2B depicts a cross section of the cable assembly of FIG. 2A taken along the lines 2B-2B.

### DETAILED DESCRIPTION OF THE INVENTION

This invention will now be described with reference to several embodiments selected for illustration in the drawings. It will be appreciated that the scope and spirit of the invention are not limited to the illustrated embodiments.

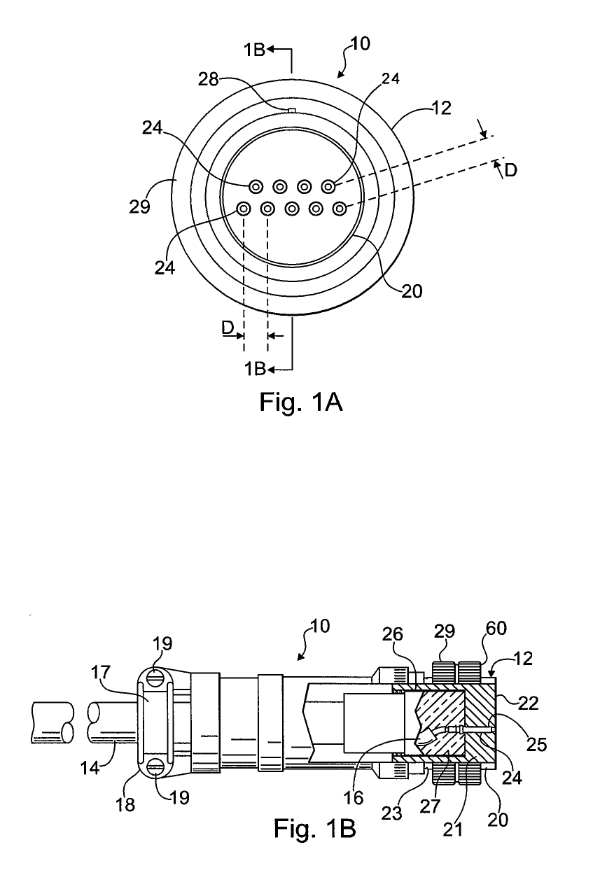

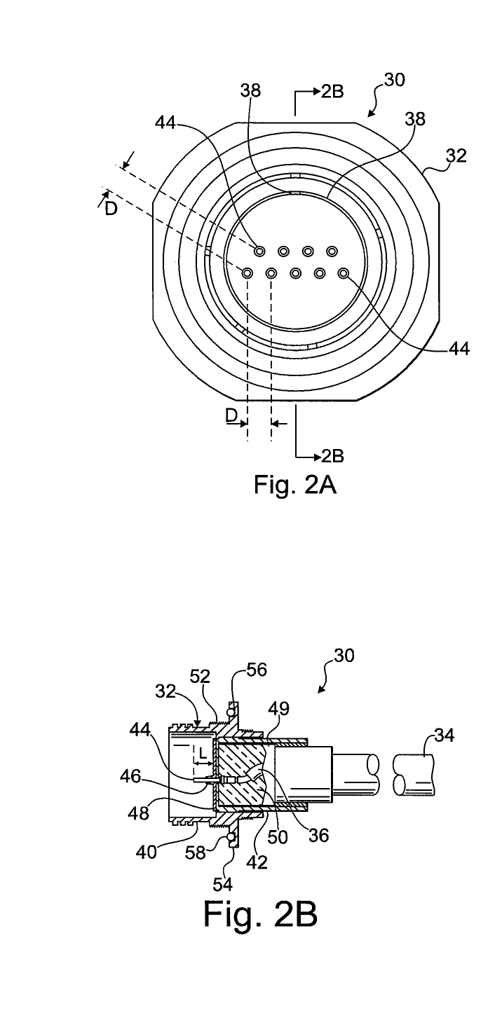

Referring generally to the figures, a mateable pair of Ethernet connector assemblies 12 and 32 for propagating data at Gigabit rates is disclosed. The pair of Ethernet connectors include female Ethernet receptacle assembly 12 (hereinafter receptacle assembly 12) and male Ethernet plug assembly 32 (hereinafter plug assembly 32). The receptacle assembly 12 is illustrated in FIGS. 1A and 1B, and plug assembly 32 is illustrated in FIGS. 2A and 2B. The plug assembly 32 and receptacle assembly 12 are releasably engageable for transferring signals at Gigabit rates as well as power, such as from a DC source (not shown).

Referring now to FIGS. 1A and 1B, FIG. 1A depicts an end view of receptacle assembly 12 of cable assembly 10 according to one exemplary embodiment of the invention, and FIG. 1B depicts a cross section of cable assembly 10 of FIG. 1A taken along the lines 1B-1B. The cable assembly 10 generally includes a receptacle assembly 12 crimped, soldered, or otherwise fastened onto an electrical cable 14, and an optional strain relief 18 coupled to cable 14 and receptacle assembly 12.

The receptacle assembly 12 comprises a substantially cylindrical hollow-body shell 20, an insulator body 21 positioned within shell 20, and a plurality of hollow cylindrical sockets 24 positioned within respective apertures 25 formed in insulator body 21. The exposed end of each socket 24 is maintained substantially flush with mating surface 22 of insulator body 21 for receiving a pin of plug assembly 32. The opposing end of each socket 24 is configured to be coupled to a single conductor 16 of electrical cable 14. Specifically, each conductor 16 is crimped, soldered, or otherwise coupled, to the end of a respective socket 24, as shown.

The insulator body 21 is cup-shaped and includes a plurality of apertures 25 that are sufficiently spaced apart for accommodating sockets 24. A single socket 24 is positioned within a single aperture 25. The insulator body 21 electrically insulates, i.e. isolates, sockets 24 from one another to reduce EMI and cross-talk. The insulator body 21 may be formed from polycarbonate for dry applications, polyurethane and epoxy for underwater applications, or any other material known to those skilled in the art.

The insulator body 21 includes a recessed portion 26 for accommodating conductors 16 of electrical cable 14. An insulative epoxy compound 27 is applied within recessed portion 26 of insulator body 21 to maintain sockets 24 and conductors 16 in a fixed position. The insulative epoxy compound 27 seals and protects the electrical connections between each socket 24 and conductor 16.

According to one aspect of the invention, receptacle assembly 12 optionally includes at least eight (8) sockets 24 for respective connection with eight (8) conductors 16 of cable 14. The cable 14 may be classified as Category 5e, Category 6, or any other style known to those skilled in the art for propagating signals (Ethernet or otherwise) and power. Because Category 5e and Category 6 cable includes a total of (or a minimum of) eight (8) conductors and receptacle assembly 12 accommodates Categories 5e and 6 cable, receptacle assembly 12 includes at least eight (8) sockets 24. The receptacle assembly 12 may also have nine (9) sockets 24, as shown, for carrying Ethernet signals, master time reference signals and power circuits.

According to one aspect of the invention, sockets 24 are cylindrically shaped contacts composed of a conductive metallic material. According to one aspect of the invention, each socket 24 is manufactured consistent with MIL-C-39029/63C revision dated Oct. 28, 1993. Each socket 24 includes an aperture having a diameter of about 0.0415 inches for receiving a pin 44 of plug assembly 32 (see FIG. 2B).

As best shown in FIG. 1B, adjacent sockets 24 are spaced apart by a pre-determined distance “D.” According to one aspect of the invention, the pre-determined distance “D” is maintained between about 0.08 inches to about 0.2 inches, or more preferably maintained at about 0.110 inches. Maintaining the pre-determined distance “D” between about 0.08 inches to about 0.2 inches minimizes the separation between conductors 16 connected to those sockets 24.

Minimizing separation between conductors 16 maintains conductors 16 in a twisted state. Numerous benefits are achieved by maintaining conductors 16 in a twisted state. Twisted pair cabling is a form of wiring in which two conductors are wound together for the purposes of canceling out electromagnetic interference (EMI) from external sources, electromagnetic radiation, and crosstalk between neighboring pairs. Twisting wires decreases interference because the loop area between the wires, which determines the magnetic coupling into the signal, is reduced. In balanced pair operation, the two wires typically carry equal and opposite signals (differential mode) which are combined by addition at the destination. When pairs are not twisted, one member of the pair may be closer to the source than the other, and thus exposed to slightly different induced EMI. Accordingly, spacing adjacent sockets 24 by a pre-determined distance “D” is beneficial for minimizing separation between conductors 16 to maintain conductors 16 in a twisted state.

According to one aspect of the invention, receptacle assembly 12 is configured to be releasably mateable with plug assembly 32 for transferring power and data at Gigabit rates. The receptacle assembly 12 includes provisions for releasably coupling with plug assembly 32. More particularly, a square-shaped alignment tab 28 is formed on an outer revolved surface of shell 20 for mating with a recess 38 (See FIG. 2A) of plug assembly 32. The tab 28 slides along the internal surfaces of recess 38. In assembly, tab 28 is aligned with recess 38 prior to mating pins 44 of plug assembly 32 with sockets 24 of receptacle assembly 12.

The tab 28 and recess 38 alignment features are provided to facilitate alignment between the pins 44 of plug assembly 32 and respective sockets 24 of receptacle assembly 12 to prevent misalignment and/or potential damage to pins 44 and respective sockets 24. Those skilled in the art will recognize that plug assembly 32 may include alignment tab 28 and receptacle assembly 12 may include recess 38 (See FIG. 2A) without departing from the scope or spirit of the invention.

The receptacle assembly 12 includes a cylindrically-shaped nut 29 for releasably fastening to plug assembly 32. The nut 29 is slideably captivated to shell 20 and rotates with respect to shell 20 for mating receptacle assembly 12 to plug assembly 32 after insertion of pins 44 into respective sockets 24. According to one aspect of the invention, nut 29 is permanently captivated (i.e., non-removable) to shell 20.

The nut 29 includes a threaded region (not shown) defined on an interior surface thereof for threadedly engaging exterior threaded region 52 of plug assembly 32 (see FIG. 2B). According to one aspect of the invention, the threaded region (not shown) is positioned adjacent shell 20. Those skilled in the art will recognize that receptacle assembly 12 may include a threaded region positioned on shell 20 (similar to threaded region 52) and plug assembly 32 may include a slideably captivated nut having internal threads adjacent shell 40 (similar to nut 29) without departing from the scope or spirit of the invention. Furthermore, those skilled in the art will also recognize that other ways exist to releasably couple receptacle assembly 12 with plug assembly 32.

The exterior surface of nut 29 is knurled, as shown, to allow easy hand tightening or loosening of nut 29. The nut 29 may also include a hex shaped surface, or other surface, for receiving a wrench.

The optional strain relief 18 is mounted to cable 14 and receptacle assembly 12 for absorbing mechanical forces applied to cable 14. One end of strain relief 18 includes a threaded region (not shown) for coupling to threads 23 of shell 20. The opposing end of stain relief 18 includes a strap 17 positioned about the perimeter of cable 14. Two fasteners 19 are fastened to strap 17 of strain relief 18 and a fixed component (not shown) for strain relieving cable 14.

Referring now to FIGS. 2A and 2B, FIG. 2A depicts an end view of plug assembly 32 of cable assembly 30 according to one exemplary embodiment of the invention, and FIG. 2B depicts a cross section of cable assembly 30 of FIG. 2A taken along the lines 2B-2B. The cable assembly 30 generally includes a plug assembly 32 crimped, soldered, or otherwise fastened onto an electrical cable 34. Although not shown, cable assembly 30 may optionally include a strain relief for absorbing mechanical forces applied to cable 34.

The plug assembly 32 comprises a substantially cylindrical hollow-body shell 40, an insulator body 42 positioned within shell 40, and a plurality of cylindrical pins 44 positioned within respective apertures 46 formed in insulator body 42. The pins 44 are releasably engageable with respective sockets 24 for establishing an electrical connection between cable 34 and cable 14. As compared with traditional RJ45 connectors, the pin and socket design described herein limits loss of data packets during shock and vibration. More particularly, upon exposure to vibration or shock, loss of electrical contact between the pins and sockets is minimized by virtue of the contact therebetween.

One end of each pin 44 extends beyond mating surface 48 of insulator body 42 by a predetermined length “L” for insertion into a respective socket 24 of receptacle assembly 12. According to one aspect of the invention, the predetermined length “L” is between about 0.1 inches and 0.35 inches. Additionally, by virtue of the predetermined length “L,” plug assembly 32 is configured to propagate Ethernet signals at Gigabit rates. The opposing end of each pin 44 is configured to be coupled to a single conductor 36 of electrical cable 34. Specifically, each conductor 36 is crimped, soldered, or otherwise coupled, to the end of a single pin 44.

As best shown in FIG. 2A, adjacent pins 44 are spaced apart by a pre-determined distance “D.” The pre-determined distance “D” is equivalent to the pre-determined distance “D” shown in FIG. 1A, such that pins 44 align and mate with sockets 24. According to one aspect of the invention, the pre-determined distance “D” is maintained between about 0.08 inches to 0.2 inches, or more preferably maintained at 0.110 inches. Maintaining the pre-determined distance “D” between about 0.08 inches to 0.2 inches minimizes the separation between conductors 36 connected to those pins 44. As noted previously, minimizing separation between conductors 36 maintains conductors 36 in a twisted state, which reduces electromagnetic interference (EMI) from external sources, electromagnetic radiation, and crosstalk between neighboring pairs.

According to one aspect of the invention, plug assembly 32 optionally includes at least eight (8) pins 44 for respective connection with eight (8) conductors 36 of cable 34. The cable 34 may be classified as Category 5e, Category 6, or any other cable style known to those skilled in the art for propagating signals (Ethernet or otherwise) and power. As stated previously, because Category 5e and Category 6 cable include a total of (or a minimum of) eight (8) conductors and plug assembly 32 accommodates Categories 5e and 6 cable, plug assembly 32 includes at least eight (8) pins 44. The plug assembly 32 may also include nine (9) pins, as shown, for carrying Ethernet signals, master time reference signals and power circuits.

According to one aspect of the invention, pins 44 are cylindrically shaped contacts composed of a conductive metallic material. Each pin 44 may be manufactured consistent with MIL-C-39029/64C revision dated Feb. 10, 1992, for example. The diameter of each pin 44 may be 0.04 inches for insertion into socket 24 of receptacle assembly 12.

Similar to insulator body 21 of FIG. 1B, insulator body 42 is cup-shaped and includes a plurality of apertures 46 (nine shown) disposed on a surface thereof for receiving pins 44. The apertures 46 are sufficiently spaced apart for electrically insulating the pins 44 from one another to reduce EMI and cross-talk and to maintain conductors 16 in a twisted state.

The insulator body 42 further includes a recessed portion 49 for accommodating conductors 36 of electrical cable 34. An insulative epoxy compound 50 is applied within recessed portion 49 of insulator body 42 to maintain pins 44 and conductors 36 in a fixed position. The insulative epoxy compound 50 seals and insulates the electrical connections between each pin 44 and conductor 36. The insulator body 42 may be formed from polycarbonate for dry applications, polyurethane and epoxy for underwater applications, or any other material known to those skilled in the art.

The plug assembly 32 includes provisions for releasably coupling with receptacle assembly 12. More particularly, recess 38 is formed on an interior revolved surface of shell 42 for mating with alignment tab 28 of plug assembly 32, as described previously with reference to FIG. 1B. The plug assembly 32 includes a threaded region 52 positioned on (or adjacent to) shell 42. In assembly, tab 28 is positioned within recess 38 and shell 20 of receptacle assembly 12 is positioned within shell 42 of plug assembly 32. Once pins 44 are sufficiently mated with sockets 24, nut 29 of receptacle assembly 12 is threaded onto threaded region 52 of shell 40 until end surface 60 of nut 29 bears against flange 54 of plug assembly 32.

The flange 54 extends from the exterior revolved surface of shell 42 and is oriented perpendicular to a longitudinal axis of shell 42 and proximal to threaded region 52. The flange 54 includes a recess 56 revolved about flange 54 for accommodating a circular o-ring 58. Rotating nut 29 onto threaded region 52 compresses end surface 60 of nut 29 with o-ring 58, creating a waterproof or moisture-proof seal therebetween. Limiting the introduction of moisture at the interface between o-ring 58 and surface 60 prevents electrical shorting of pins 44 and sockets 24.

Accordingly, the connector assemblies 12 and 32 may be utilized for underwater applications, such as outboard of a submarine or undersea systems on oil and gas exploration platforms. The connector assemblies 12 and 32 may also be utilized for surface or inboard applications of ships, submarines, tanks and aircraft and land systems.

According to one aspect of the invention, the mated cable assemblies 10 and 30 are rated to propagate voltage of less than or equal to 5 volts, and current of less than or equal to 1 milliamp. While the connector assemblies 12 and 32 described herein may be tailored for propagating Ethernet signals, the connectors are not limited to such use.

Although the invention is illustrated and described herein with reference to specific embodiments, the invention is not intended to be limited to the details shown. Rather, various modifications may be made in the details within the scope and range of equivalents of the claims and without departing from the spirit of the invention.

What is claimed:

1. A mateable pair of Ethernet connector assemblies for propagating data at Gigabit rates, said pair of electrical connector assemblies comprising:
a male Ethernet plug including a substantially cylindrical hollow-body shell, an insulator body positioned within the shell and defining a mating surface, a plurality of cylindrical pins positioned within respective apertures formed in the insulator body, one end of each pin extending beyond the mating surface of the insulator body for insertion into a respective socket of a female receptacle, and a threaded region positioned on or adjacent the shell for threadedly coupling to the female receptacle; and
the female Ethernet receptacle including a substantially cylindrical hollow-body shell, an insulator body positioned within the receptacle shell and defining a mating surface, a plurality of hollow-body cylindrical sockets positioned within respective apertures formed in the receptacle insulator body, one end of each socket being substantially flush with the mating surface of the receptacle insulator body for receiving a pin of the male Ethernet plug, and a threaded region positioned on or adjacent the receptacle shell for threadedly coupling to the threaded region of the plug shell.

2. The mateable pair of claim 1, wherein adjacent cylindrical pins are spaced apart by a pre-determined distance, and adjacent sockets are spaced apart by the same pre-determined distance.

3. The mateable pair of claim 2, wherein the pre-determined distance is greater than about 0.08 inches and less than about 0.2 inches.

4. The mateable pair of claim 1, wherein the pre-determined length of each pin is sufficient for insertion into a corresponding socket of the receptacle and for propagating data at Gigabit rates.

5. The mateable pair of claim 4, wherein the pre-determined length is greater than about 0.1 inches and less than about 0.35 inches.

6. The mateable pair of claim 1, wherein the engageable pair are configured to propagate voltage of less than or equal to 5 volts, and current less than or equal to 1 milliamp.

7. The mateable pair of claim 1, said plug comprising at least eight pins for respective engagement with at least eight sockets of the female receptacle.

8. The mateable pair of claim 1 further comprising an alignment tab extending from the shell of either the plug or the receptacle for engaging a recess formed in the shell of either the receptacle or the plug, respectively, for aligning the pins and the sockets of the mateable pair.

9. The mateable pair of claim 1 further comprising an o-ring positioned between the shell of the male Ethernet plug and the shell of the female Ethernet receptacle for limiting the ingress of moisture within the shells of the plug and the receptacle.

10. A male Ethernet plug assembly for propagating data at Gigabit rates, the plug assembly comprising:
a substantially cylindrical hollow-body shell;
an insulator body positioned within the shell and defining a mating surface;
a plurality of cylindrical pins positioned within respective apertures formed in the insulator body, wherein adjacent cylindrical pins are spaced apart by a pre-determined distance,
one end of each pin extending beyond the mating surface of the insulator body by a predetermined length for insertion into a socket of the female Ethernet receptacle, and the opposing end of each pin being configured to be coupled to an electrical wire; and
a threaded region positioned on or adjacent the shell for threadedly coupling to the female Ethernet receptacle.

11. The male Ethernet plug assembly of claim 10, wherein the pre-determined distance is greater than about 0.08 inches and less than about 0.2 inches.

12. The male Ethernet plug assembly of claim 10, wherein the pre-determined length is greater than about 0.1 inches and less than about 0.35 inches.

13. The male Ethernet plug assembly of claim 10, said plug including at least eight pins for respective engagement with at least eight sockets of the female Ethernet receptacle.

14. The male Ethernet plug assembly of claim 10 further comprising a flange oriented perpendicular to a longitudinal axis of the shell and proximal to the threaded region of the shell, said flange including a recess for accommodating an o-ring, said o-ring being positioned for engagement with a surface of the female Ethernet receptacle.

15. A female Ethernet receptacle assembly for propagating data at Gigabit rates, the receptacle assembly comprising:
a substantially cylindrical hollow-body shell;
an insulator body positioned within the shell and defining a mating surface;
a plurality of hollow cylindrical sockets positioned within respective apertures formed in the insulator body, wherein adjacent sockets are spaced apart by a pre-determined distance,
one end of each socket being substantially flush with the mating surface of the receptacle insulator body for receiving a pin of a male Ethernet plug, and an opposing end of each socket being configured to be coupled to an electrical wire; and
a threaded region positioned on or adjacent said shell for threadedly coupling to the male Ethernet plug.

16. The female Ethernet receptacle assembly of claim 15, wherein the pre-determined distance is greater than about 0.08 inches and less than about 0.2 inches.

17. The female Ethernet receptacle assembly of claim 15, said receptacle including at least eight sockets for respectively receiving at least eight pins of the male plug.

18. The female Ethernet receptacle assembly of claim 15, further comprising a nut slideably captivated to said shell, said threaded region defined on an interior surface of said nut for threadedly engaging a threaded region of the male Ethernet plug.

19. A twisted pair cable assembly for propagating data at Gigabit rates comprising:
a first twisted pair cable having at least eight conductors;
a second twisted pair cable having at least eight conductors;
a male Ethernet plug including a substantially cylindrical hollow-body shell, an insulator body positioned within the shell and defining a mating surface, at least eight cylindrical pins positioned within respective apertures formed in the insulator body, one end of each pin extending beyond the mating surface of the insulator body for insertion into a respective socket of a female Ethernet receptacle and an opposing end of each pin being coupled to a respective conductor of the first twisted pair cable, and a threaded region positioned on or adjacent the shell for threadedly coupling to the receptacle; and
the female Ethernet receptacle including a substantially cylindrical hollow-body shell, an insulator body positioned within the receptacle shell and defining a mating surface, at least eight hollow-body cylindrical sockets positioned within respective apertures formed in the receptacle insulator body, one end of each socket being substantially flush with the mating surface of the receptacle insulator body for receiving a pin of the male Ethernet plug and an opposing end of each socket being coupled to a respective conductor of the second twisted pair cable, and a threaded region positioned on or adjacent the shell of the receptacle for threadedly coupling to the threaded region of the plug shell.

20. The twisted pair cable assembly of claim 19, wherein adjacent cylindrical pins of the male plug are spaced apart by a pre-determined distance, and adjacent sockets of the female receptacle are spaced apart by the same pre-determined distance.

21. The twisted pair cable assembly of claim 20, wherein the pre-determined distance is greater than about 0.08 inches and less than about 0.2 inches.

22. The twisted pair cable assembly of claim 19, wherein the pre-determined length of each pin is sufficient for insertion into a corresponding socket of the receptacle for propagating data at Gigabit rates.

23. The twisted pair cable assembly of claim 22, wherein the pre-determined length is greater than about 0.1 inches and less than about 0.35 inches.

24. The twisted pair cable assembly of claim 19, wherein the twisted pair cable assembly is configured to propagate voltage of less than or equal to 5 volts, and current of less than or equal to 1 milliamp.
